(19) United States
(12) Patent Application Publication
(10) Pub. No.: US 2005/0202237 A1
(43) Pub. Date: Sep. 15, 2005

(54) Heat shield having a sealed edge

(75) Inventors: Samuel B. Fryberger JR., Spring City, PA (US); Timothy D. Sellis, West Grove, PA (US); John E. Burdy, Morgantown, PA (US)

Correspondence Address: SYNNESTVEDT & LECHNER, LLP, 2600 ARAMARK TOWER, 1101 MARKET STREET, PHILADELPHIA, PA, 191072950, US

(73) Assignee: Federal-Mogul World Wide, Inc., Southfield, MI (US)

(21) Appl. No.: 11/077,306

(22) Filed: Mar. 10, 2005

Related U.S. Application Data
(60) Provisional application No. 60/551,682, filed on Mar. 10, 2004.

(51) Int. Cl. B32B 7/12; B32B 27/04

(52) U.S. Cl. 428/354; 442/151; 428/480

(57) ABSTRACT

A heat shield is disclosed having a first layer with a reflective surface, a second, heat fusible layer, a third insulating and reinforcing layer, and a fourth layer formed of pressure sensitive adhesive. The edges of the layers align with one another to form a common perimeter to which heat and pressure are applied to fuse the heat fusible layer to the other layers and bond the layers to one another. The heat fusible layer forms a seal on the perimeter that prevents the diffusion of fluids between the layers.

### FIELD OF THE INVENTION

The invention relates to heat shields for protecting items subjected to radiant heat sources.

### BACKGROUND OF THE INVENTION

Automotive, aeronautical and marine components positioned in engine compartments or near heat sources such as exhaust manifolds may be subjected to harsh thermal environments involving high temperature radiant heat transfer. Further, undesired heat transfer may also occur between heat sources such as engines, exhaust systems and/or transmissions and the passenger compartment of an automobile, aircraft or boat.

It is found advantageous to use insulating panels comprised of a number of overlying layers to reduce heat transfer from a heat source to other adjacent components. The insulating layers comprising the panel may include, for example, a reflective surface such as aluminum foil, an insulating scrim layer of temperature resistant material such as woven fiberglass, and a backing layer comprising a pressure sensitive adhesive for attachment of the insulating panel to a component or structure.

While such insulating panels are effective at reducing radiant heat transfer, they are often inappropriate for use where they will be subjected to contaminating fluids such as oil, gasoline, engine coolants such as ethylene glycol, hydraulic fluids as well as water which is encountered in almost any environment. The fluids tend to penetrate between the various layers through exposed edges of the panels and accumulate within the panels. This diminishes the insulative effectiveness of the panels and often leads to their accelerated corrosion and deterioration. If the fluids are flammable, the panels can become a fire hazard as well. It would be advantageous to provide insulating panels forming a heat shield that could be used in the presence of fluids without the aforementioned disadvantages.

### SUMMARY OF THE INVENTION

The invention concerns a heat shield effective at reducing radiant heat transfer. The heat shield comprises a first layer having a reflective surface and a first edge and a second layer comprising a fusible material positioned overlying the first layer. The second layer has a second edge aligned with the first edge. The heat shield also includes a third layer positioned overlying the second layer. The third layer has a third edge aligned with the first and second edges of the first and second layers. A portion of the second layer is fused to the first and third layers along the first, second and third edges thereby forming a seal along these edges that prevents fluid from penetrating between the various layers.

Preferably, the first layer comprises an aluminum foil, and the second layer comprises a non-woven polymer such as polyester. The third layer may comprise another layer of aluminum or could also be a pressure sensitive adhesive substrate to allow the heat shield to be conveniently attached to a surface or structure.

An insulating layer may be positioned between the first and the third layers. Such a layer may comprise a woven glass fiber substrate, glass fiber being advantageous for high temperature applications.

### BRIEF DESCRIPTION OF THE DRAWINGS

FIG. 1 is a perspective view of a heat shield according to the invention;

FIG. 2 is a perspective view of another embodiment of a heat shield;

FIG. 3 is a perspective view of another embodiment of a heat shield; and

FIG. 4 is an exploded perspective view of another embodiment of a heat shield.

### DETAILED DESCRIPTION OF PREFERRED EMBODIMENTS

FIG. 1 provides a perspective view of an embodiment of a heat shield 10 according to the invention. Heat shield 10 comprises a first layer 12 having a reflective surface 14 that is positioned facing a heat source when shield 10 is installed to protect a component or insulate a portion of a structure. Preferably, the first layer comprises an aluminum foil substrate that may range in thickness between 0.001 inches and 0.02 inches for practical applications. Other metals such as steel are also feasible.

First layer 12 is in overlying relation with a second layer 16 formed of a heat fusible material. Second layer 16 is preferably a non-woven material made of a polymer such as polyester. The non-woven layer may range in thickness between 0.05 inches and 0.25 inches and is preferably fusible over a temperature range between about 245° C. and about 265° C. A third layer 18 overlies the second layer on a side opposite the first layer 12, the second layer 16 being sandwiched between the first and third layers. The third layer 18 may also comprise a reflective surface like the first layer or it may be a layer of pressure sensitive adhesive substrate that provides a means for attaching the heat shield 10 to a component or other structure as described below.

Each of the layers 12, 16 and 18 have at least one edge 12a, 16a and 18a, respectively, that substantially align with one another and form a portion 20 of a perimeter 22 of the heat shield 10. The layers 12, 16 and 18 are joined to one another by applying heat and pressure along at least edges 12a, 16a and 18a but preferably substantially continuously along all of the edges defining the perimeter 22. Various methods may be employed to apply the heat and pressure, such as by means of ultrasonic rotary dies, ultrasonic die stamping, a heated rotary die, and hot die stamping. Crimping of the edge may also be used to apply pressure, and flame cutting or flame applied directly to the perimeter applies heat.

The heat and pressure melt a portion of the second layer 16 near and at the various edges to which the heat and pressure are applied. This causes the second layer 16 to bond with the first and third layers 12 and 18, joining the layers together to form the heat shield 10 when the second layer cools and fuses. Because it melts and fuses, the second layer 16 forms a seal 24 along the edges that prevents fluid from diffusing between the layers 12, 16 and 18 as would otherwise happen if a seal were not present. Preferably, the seal 24 extends completely around the entire perimeter 22 of the heat shield. It is also possible to melt either or both of the first and third layers in the region of the edges to have increased interpenetration between the first and third layers 12 and 18 and the second layer 16. Joining the layers along edges such as 12a, 16a and 18a also helps to prevent delamination of the heat shield 10, especially when the edges are joined around the entire periphery 22.

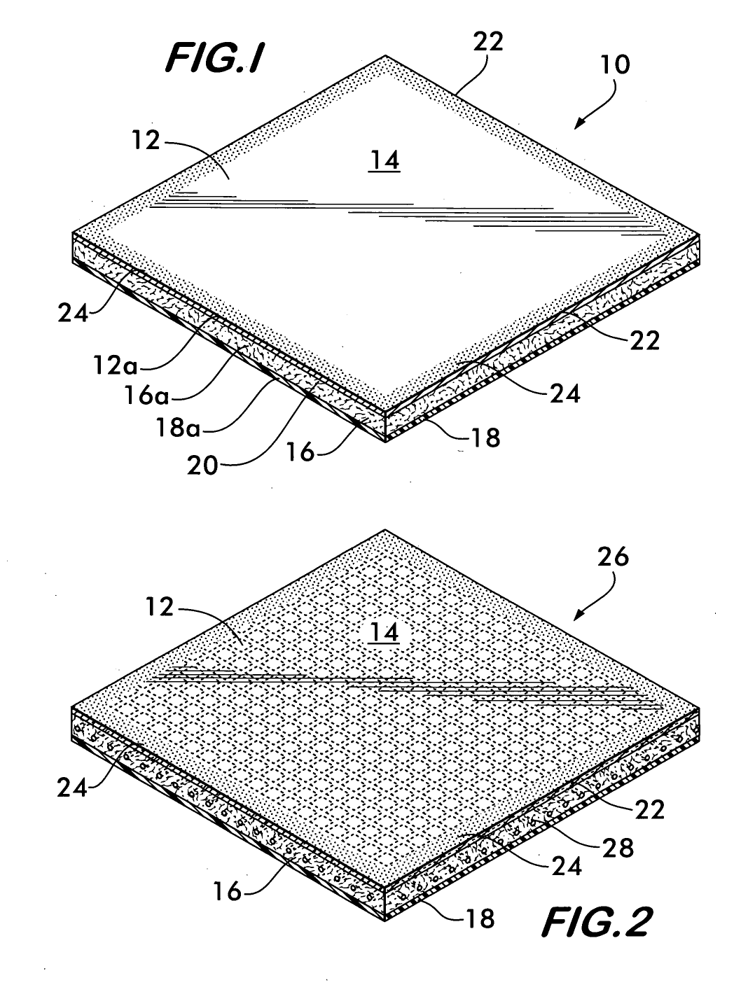

FIG. 2 shows a heat shield 26 having the heat fusible layer 16 sandwiched between the outer layers 12 and 18 as well as an insulating/reinforcing layer 28. Insulating/reinforcing layer 28 is preferably a tough, heat resistant insulating substrate, such as a woven glass fiber scrim having a coarse mesh. The scrim allows reinforcing layer 28 to readily embed itself within the heat fusible layer 16 when heat and pressure are applied to the perimeter 22 to bond the layers together. In addition to keeping fluids from diffusing between the various layers, the seal 24 that is formed along the periphery 22 as a result of the melting and fusing of layer 16 acts to encapsulate the insulating/reinforcing layer 28, preventing glass fibers, for example, from extending outwardly from the periphery.

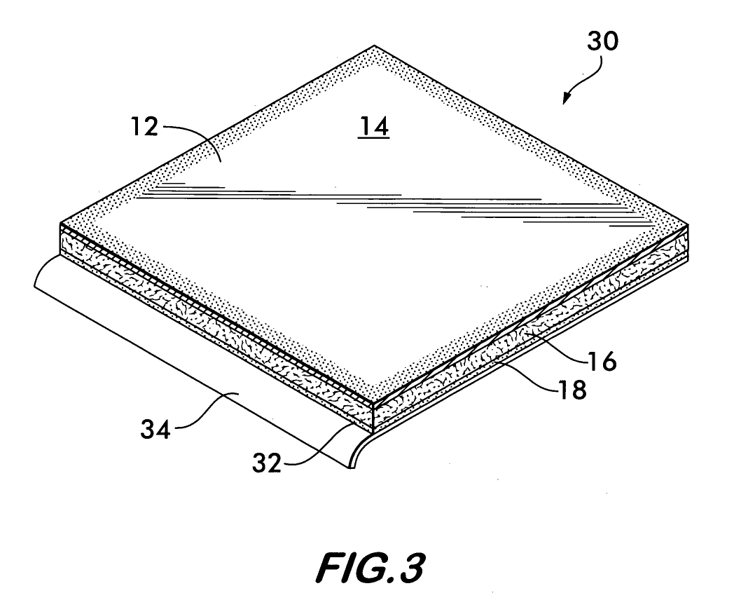

FIG. 3 illustrates another embodiment 30 of the heat shield according to the invention, heat shield 30 comprising the layer 12 having the reflective surface 14, the heat fusible layer 16 and a layer 18 in the form of a pressure sensitive adhesive substrate 32. The adhesive substrate 32 may have a protective paper layer 34 that is removable when it is desired to adhesively attach the heat shield 30 to a component or structure for thermal protection.

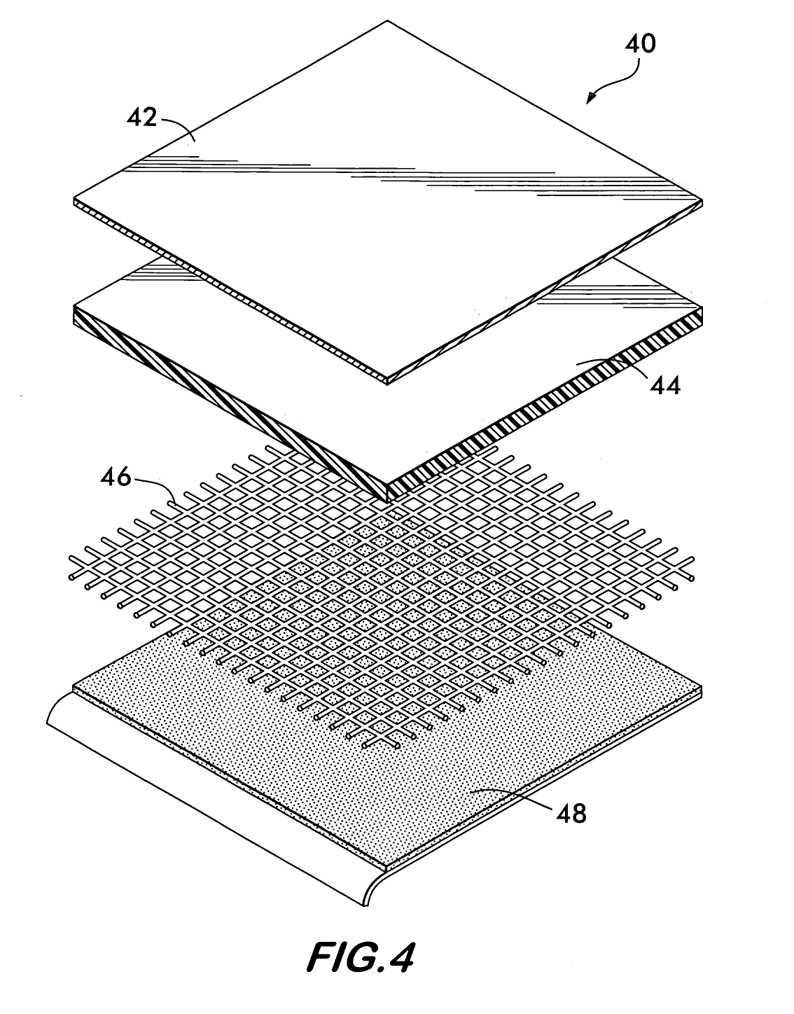

FIG. 4 shows an exploded view of another embodiment 40 of the heat shield wherein the first layer 42 comprises a metallic coating, such as aluminum or gold that is deposited on a surface of the second layer 44. Gold is advantageous when particularly high reflectivities are required, such as in spacecraft applications. The gold or other metal may be deposited via sputter or vacuum deposition techniques. The second layer 44 is preferably polyethylene terephthalate, as it provides a smooth surface for the metallic coating and thus will yield an effective reflective surface. The polyethylene terephthalate also has a relatively low melting point, allowing it to readily fuse with the insulating/reinforcing layer 46, and the pressure sensitive adhesive layer 48 or other layer when heat and pressure are applied to the perimeter to effect the formation of a seal around the perimeter of the shield.

Manufacture of heat shields according to the invention is preferably effected using ultrasonic welding equipment such as the Sonobond Ultrasonic Welder or the Branson Ultrasonic Welder to apply heat and pressure to the edges along the perimeter of the heat shield. Other techniques, such as clamping the edges between hot surfaces or dies would also be effective at creating the seal 24 around perimeter 22.

Heat shields according to the invention may be applied to automobile chassis between a heat source and the passenger compartment to inhibit radiant heat transfer. Examples of heat sources include exhaust pipes, the engine compartment, as well as the transmission. Because they have sealed edges, heat shields according to the invention are especially useful where fluids are found. For example, the heat shield may be positioned around a master cylinder of a brake system, a power steering pump or hydraulic fluid reservoir, fluid windshield washer reservoir or near the engine radiator without fear that the heat shield will become contaminated by the fluids with which it will come into contact.

1. A heat shield comprising:
a first layer having a reflective surface and a first edge;
a second layer comprising a heat fusible material positioned overlying said first layer, said second layer having a second edge substantially aligned with said first edge; and
a third layer positioned overlying said second layer and having a third edge substantially aligned with said first and second edges, a portion of said second layer along said second edge being fused to said first and third layers along said first and third edges thereby forming a seal between said first and third layers.

2. A heat shield according to claim 1, wherein said first layer comprises an aluminum foil.

3. A heat shield according to claim 1, wherein said second layer comprises a polymer substrate.

4. A heat shield according to claim 2, wherein said second layer comprises a non-woven polyester substrate.

5. A heat shield according to claim 1, wherein said third layer comprises a pressure sensitive adhesive substrate.

6. A heat shield according to claim 1, further comprising a fourth layer positioned between said first and said third layers and having a fourth edge substantially aligned with said first, second and third edges, a portion of said fourth layer being fused to said second layer along said fourth edge and forming said seal between said first and third layers.

7. A heat shield according to claim 6, wherein said fourth layer comprises a woven glass fiber substrate.

8. A heat shield according to claim 1, wherein said third layer comprises an aluminum foil.

9. A heat shield according to claim 1, wherein said first layer comprises a metallic coating and said second layer comprises polyethylene terephthalate, said metallic coating being deposited on said polyethylene terephthalate.

10. A heat shield comprising:
a first layer having a reflective surface and a first perimeter surrounding said first layer;
a second layer comprising a heat fusible material positioned overlying said first layer, said second layer having a second perimeter surrounding said second layer; and
a third layer positioned overlying said second layer and having a third perimeter surrounding said third layer, said first, second and third perimeters being substantially aligned with one another, a portion of said second layer along said second perimeter being fused to said first and third layers along said first and third perimeters and thereby forming a seal between said first and third layers.

11. A heat shield according to claim 10, wherein said first layer comprises an aluminum foil.

12. A heat shield according to claim 10, wherein said second layer comprises a polymer substrate.

13. A heat shield according to claim 11, wherein said second layer comprises a non-woven polyester substrate.

14. A heat shield according to claim 12, wherein said third layer comprises a pressure sensitive adhesive substrate.

15. A heat shield according to claim 10, further comprising a fourth layer positioned between said first and said third layers and having a fourth perimeter surrounding said fourth layer, said fourth perimeter substantially aligned with said first, second and third perimeters, a portion of said fourth layer being fused to said second layer along said fourth perimeter thereby forming said seal surrounding said layers.

16. A heat shield according to claim 15, wherein said fourth layer comprises a woven glass fiber substrate.

17. A heat shield according to claim 10, wherein said third layer comprises an aluminum foil.

18. A heat shield comprising:
an aluminum foil layer having a first perimeter;
a glass fiber layer positioned overlying said aluminum foil layer, said glass fiber layer having a second perimeter;
a polyester layer positioned overlying said glass fiber layer, said polyester layer having a third perimeter; and
an adhesive layer positioned overlying said polyester layer, said adhesive layer having a fourth perimeter, said first, second, third and fourth perimeters being substantially aligned with one another, a portion of said polyester layer along said second perimeter being fused to said aluminum foil layer, said glass fiber layer and said adhesive layer along said first, third and fourth perimeters and thereby forming a seal between said layers.
